(19) United States
(12) Patent Application Publication
(10) Pub. No.: US 2025/0362645 A1
(43) Pub. Date: Nov. 27, 2025

(54) LIQUID EJECTION USING THERMALLY LOADED AIR SPRING

(71) Applicant: Apple Inc., Cupertino, CA (US)

(72) Inventors: Matthias IKEDA, Cupertino, CA (US); Gregory B. ARNDT, San Jose, CA (US); Vincenzo COSTANZA, San Diego, CA (US); Riley L. MAGEE, Poway, CA (US); Arturo A. ZUNIGA LOPEZ, San Jose, CA (US); Michael J. GLICKMAN, Mountain View, CA (US)

(21) Appl. No.: 19/023,020

(22) Filed: Jan. 15, 2025

Related U.S. Application Data
(60) Provisional application No. 63/651,727, filed on May 24, 2024.

(51) Int. Cl. G04B 43/00; G01N 27/22; G04B 37/08

(52) U.S. Cl. CPC G04B 43/00; G01N 27/223; G04B 37/08

(57) ABSTRACT

Aspects of the subject technology relate to electronic devices with electronic components housed within cavities of the electronic device. Liquid occlusion may be mitigated by ejecting the occluding liquid with thermally controlled pressure modulation. An electronic device includes a housing having an opening and also includes electronic components disposed within a first cavity adjacent to the opening and exposed to an environment external to the housing via the opening. The device includes a heating element disposed within a second cavity adjacent to the first cavity. The device includes processing circuitry configured to determine that the opening is occluded and activate the heating element to eject a liquid through the opening to the environment by increasing a gas pressure within the second cavity based on a change in temperature in the second cavity by heating a gas volume inside the second cavity with the heating element.

### CROSS-REFERENCE TO RELATED APPLICATION(S)

This application claims the benefit of U.S. Provisional Application Ser. No. 63/651,727, entitled “LIQUID EJECTION USING THERMALLY LOADED AIR SPRING,” and filed on May 24, 2024, the disclosure of which is expressly incorporated by reference herein in its entirety.

### TECHNICAL FIELD

The present description relates generally to portable electronic devices, and more particularly, but not exclusively, to portable electronic devices with pressure sensors.

### BACKGROUND

Electronic devices often include small electronic components housed within cavities of the electronic devices. However, challenges can arise when environmental aggressors permeate these cavities in a portable electronic device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a schematic diagram of an electronic device having a pressure sensor in accordance with various aspects of the subject technology.

FIG. 2 illustrates a perspective view of an example electronic device implemented as a wearable device in accordance with various aspects of the subject technology.

FIG. 3 illustrates a cross-sectional side view of a liquid occluded pressure sensor port in a housing of an electronic device in accordance with various aspects of the subject technology.

FIG. 4 illustrates a cross-sectional side view of a pressure sensor disposed in a pressure sensor port in a housing of an electronic device in accordance with various aspects of the subject technology.

FIG. 5A illustrates a cross-sectional side view of a pressure sensor disposed in a pressure sensor port in a housing of an electronic device with a one-way valve in a closed position in accordance with various aspects of the subject technology.

FIG. 5B illustrates a cross-sectional side view of a pressure sensor disposed in a pressure sensor port in a housing of an electronic device with the one-way valve in an open position in accordance with various aspects of the subject technology.

FIG. 6 illustrates a cross-sectional side view of a pressure sensor disposed in a pressure sensor port in a housing of an electronic device in accordance with various aspects of the subject technology.

FIG. 7 illustrates a flow chart of an example process for identifying pressure sensor occlusion in accordance with various aspects of the subject technology.

FIG. 8 illustrates a flow chart of an example process for taking corrective action for an identified pressure sensor occlusion in accordance with various aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Portable electronic devices such as a mobile phones, portable music players, smart watches, and tablet computers are provided that include a pressure sensor, speaker and/or microphone. Pressure sensors are disposed within a housing of the portable electronic device and can sense the environmental pressure outside the housing due to airflow from outside the housing into the housing at various openings or ports. A speaker may be disposed within the housing of the portable electronic device and can output audible sound through an opening or port in the housing. Similarly, a microphone may be disposed within the housing of the portable electronic device and can receive audible sound through an opening or port in the housing. However, the opening, and/or an internal volume of the port within which the pressure sensor, speaker and/or microphone is disposed, can become occluded by environmental aggressors such as a liquid, a portion of a user's skin, or a piece of clothing at or near the port, all of which can alter the performance of the sensor.

The performance of a liquid occluded pressure sensor, speaker or microphone can deteriorate significantly. This degradation occurs because the liquid can block airflow to the sensor (occlusion) and capillary forces can pull on the sensing membrane or gel. In the case of occlusion, the pressure at the sensor may no longer equalize to the outside air, and any volume from evaporation can create a false pressure signal. In the occlusion case, any enclosed volume of air will follow the ideal gas law, creating a large temperature coefficient of offset (TCO). In the case of a microphone, occlusion can block sounds, and bursting of bubbles and membrane can create sounds that are detected as very loud. Therefore, it is desirable to actively remove the aggressor (e.g., water) from these confined spaces to ensure optimal operation of the electronic components housed within the cavities of the electronic device.

Embodiments of the subject technology provide for the mitigation of occlusion in a cavity of an electronic device by removal of the liquid occlusion with thermally controlled pressure modulation. The primary cause of the liquid occlusion is typically the presence of a particulate protection element in the portable electronic device, such as a mesh or a protective cap. For example, in the case of a pressure sensor, a liquid film will form within apertures of the particulate protection element thus leading to the occlusion of liquid, and therefore obstructing pressure transmission.

The objective of this approach is to expel the liquid with minimal power consumption by way of manipulating the gas pressure within the cavity using thermodynamics, consequently causing the air in the pocket to expand and break through the film caused by the occluded liquid trapped within the apertures of the particulate protection element. By incorporating heaters, the temperature of the gas can be selectively adjusted, thereby inducing pressure changes within the cavity. This alteration in pressure prompts the gas to expand, effectively displacing water from the cavity and restoring electronic component functionality. The gas inside the pocket adheres to the thermodynamic principles of the ideal gas law, facilitating controlled pressure modulation.

The subject technology harnesses the inherent spring-like properties of the air pocket, which can be activated through temperature control. Implementation of this concept involves integrating heating elements strategically within the electronic device. In accordance with various aspects of the subject disclosure, a portable electronic device is provided that includes a heating element disposed in a cavity. Processing circuitry in the portable electronic device identifies occlusions of the cavity and expels the occluding liquid with thermally controlled pressure modulation of the occluding liquid, as described in further detail hereinafter. The heating element may be implemented as a coil intended for heating purposes. In one or more other implementations, the heating element may be a wire-bond wire. In one or more other implementations, the heating element may be a film-based heater integrated onto the walls of the cavity. Placing the heating element onto the walls of the cavity can involve a layered arrangement, in which heating trace elements are integrated, likely forming part of the structure.

Instead of solely converting the occluding liquid (e.g., water) to vapor, which requires substantial energy consumption by the device, the approach emphasizes the forceful expulsion of both air and liquid using the pressure generated by the thermally driven expansion of the gas in the cavity. Embodiments of the subject technology offer several advantages over other approaches such as water evaporation or electrolysis. Notably, it minimizes energy consumption by focusing heating efforts solely on the air pocket, as opposed to heating the entire volume of water. By prioritizing expulsion over complete phase conversion, the efficiency of the process is significantly enhanced. Additionally, alternative techniques involving electrolysis or magnetic systems present significant challenges in terms of energy efficiency and implementation complexity. Embodiments of the subject technology provides for addressing liquid occlusion and pressure-related challenges in pressure sensors and/or microphone ports, ultimately improving their overall performance. By leveraging thermal dynamics and the inherent properties of gases, the subject technology provides for a robust and energy-efficient means of safeguarding device functionality in the presence of moisture.

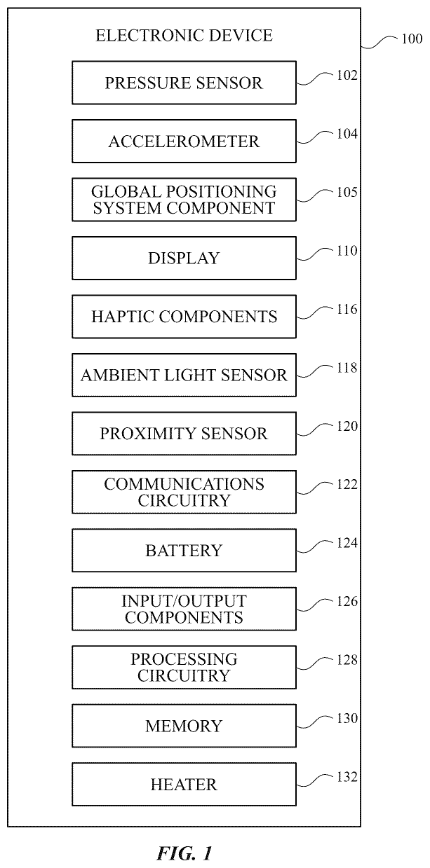

A schematic block diagram of an illustrative electronic device with a pressure sensor is shown in FIG. 1. In the example of FIG. 1, device 100 includes pressure sensor 102 and accelerometer 104. Pressure sensor 102 includes a pressure sensing element (e.g., a micro-electromechanical system (MEMS) element, a piezo element, a membrane coupled to a capacitive or resistive transducer circuit, etc.) for sensing environmental pressure and may include processing circuitry 128 for the pressure sensor 102. Accelerometer 104 includes electronic components that generate an acceleration signal responsive to physical accelerations of the accelerometer 104 (e.g., due to acceleration of device 100). The pressure sensor 102 is sometimes used for barometric pressure measurements, which can be used to identify changes in elevation. The changes in elevation are sometimes used to identify a location or exercise performed by a user of the device (e.g., by an activity monitor application running on processing circuitry of the device when the device is worn or carried by the user while the user walks or runs up a flight of stairs or up a hill).

Device 100 also includes processing circuitry 128 and memory 130. Memory 130 may include one or more different types of storage such as nonvolatile memory (e.g., flash memory or other electrically-programmable-read-only memory), volatile memory (e.g., static or dynamic random-access-memory), magnetic or optical storage, permanent or removable storage and/or other non-transitory storage media configure to store static data, dynamic data, and/or computer readable instructions for processing circuitry 128. Processing circuitry 128 may be used in controlling the operation of device 100. Processing circuitry 128 may sometimes be referred to as system circuitry or a system-on-chip (SOC) for device 100.

Processing circuitry 128 may include a processor such as a microprocessor and other suitable integrated circuits, multi-core processors, one or more application specific integrated circuits (ASICs) or field programmable gate arrays (FPGAs) that execute sequences of instructions or code, as examples. In one suitable arrangement, processing circuitry 128 may be used to run software for device 100, such as activity monitoring applications, pressure sensing applications, acceleration sensing application, occlusion detection applications using pressure data and accelerometer data, internet browsing applications, email applications, media playback applications, operating system functions, software for capturing and processing images, software implementing functions associated with gathering and processing sensor data, software that controls audio, visual, and/or haptic functions.

In the example of FIG. 1, device 100 also includes display 110, communications circuitry 122, battery 124, and input/output components 126. Input/output components 126 may include a touch-sensitive layer of display 110, a keyboard, a touch-pad, and/or one or more real or virtual buttons. Input/output components 126 may also include audio components such as one or more speakers and/or one or more microphones. In some scenarios a speaker membrane or a microphone membrane can be operated to move air to affect and/or clear occlusions of one or more ports in a housing of device 100.

One or more heaters such as heater 132 (e.g., resistive heating elements or other heating elements) may be provided in device 100. Heater 132 may be operated by processing circuitry 128 to help clear a liquid occlusion by expelling the occluding liquid by raising the temperature of an air pocket formed around the heater 132 and within a liquid to force the occluded liquid to expel out through an opening or port of the device 100. In one or more implementations, the heater 132 may also be referred to as a heating element.

Communications circuitry 122 may be implemented using WiFi, near field communications (NFC), Bluetooth®, radio, microwave, and/or other wireless and/or wired communications circuitry. Communications circuitry 122 may be operated by processing circuitry 128 based on instructions stored in memory 130 to perform cellular telephone, network data, or other communications operations for device 100. Communications circuitry 122 may include WiFi and/or NFC communications circuitry operable to communicate with an external device such a mobile telephone or other remote computing device. In some scenarios, data communications with an external device such as communications by circuitry 122 of a smart watch with a host mobile phone may allow the use of data from the external device, in combination with pressure sensor data and/or acceleration data from the watch to identify and/or characterize a pressure sensor occlusion.

As shown in FIG. 1, device 100 may include other components such as a global positioning system (GPS) component 105, haptic components 116 (e.g., one or more vibratory or other actuable devices that can produce tactile responses for a user and/or other desired accelerations of device 100), and/or other sensors such as ambient light sensor 118 and/or proximity sensor 120.

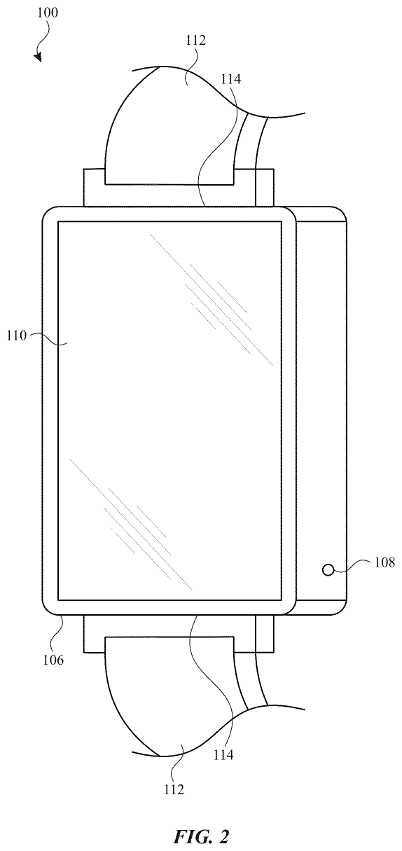

FIG. 2 is a perspective view of electronic device 100 in a configuration in which electronic device 100 has been implemented in the form of a wearable device such as smart watch. As shown in FIG. 2, display 110 may be disposed on a front surface of housing 106. Housing 106 may include one or more openings such as opening 108. In the example of FIG. 2 opening 108 is formed in a sidewall of housing 106 and provides a fluid coupling for airflow between an environment external to housing 106 into a portion of housing 106. Pressure sensor 102 may be disposed internal to housing 106 adjacent to opening 108 to receive airflow from the external environment through opening 108.

Any or all of components 102, 104, 105, 116, 118, 120, 124, 126, 128, 130 and 132 of FIG. 1 may be disposed on or within housing 106. One or more additional openings in housing 106 may be provided for a speaker, a microphone, an ambient light sensor, and/or a proximity sensor. Strap 112 may be coupled to housing 106 at interfaces 114 and arranged to secure device 100 to a part of a user's body such as around the user's wrist.

In the case of a pressure sensor, water present in the opening 108 presents a challenge due to its significant influence on pressure sensor readings. Traditional drying times for typical sensor and port geometries in consumer electronics are approximately 1 hour. To expedite this process and reduce the duration during which accurate pressure data is unavailable, active water ejection mechanisms are desirable.

In one or more implementations, the input/output components 126 such as a speaker can be utilized to generate pressure pulses for water ejection. However, for port geometries not linked to the speaker volume, this approach may not be viable. In one or more other implementations, integrating a speaker-like mechanism (comprising a magnet and coil) to generate pressure within the sensor volume or inducing water evaporation through heat can be used. In still one or more other implementations, electrolyzing water into H₂ and O₂ gas can be performed. In one or more implementations, these techniques either pose challenges and expenses in miniaturization (speaker-like method) or demand substantial energy consumption (evaporation and electrolysis), raising safety concerns (electrolysis).

Embodiments of the subject technology facilitate water ejection from confined spaces, such as the pressure sensor 102 and its pressure port (e.g., the opening 108), circumventing safety concerns associated with electrolysis. The objective of this approach is to expel the liquid with minimal power consumption by way of manipulating the gas pressure within the cavity using thermal dynamics, consequently causing the pressure in the pocket to expand and break through the film caused by the occluded liquid trapped within the apertures of the particulate protection element. Moreover, the energy requirement is substantially lower than that of electrolysis or evaporation techniques. Additionally, due to its straightforward nature, the technique can be casily integrable into compact packages and spaces.

Furthermore, aside from liquid ejection, embodiments of the subject technology may enhance the reliability of the pressure sensor 102 by providing a means to remove chemical residues from the opening 108. In one or more implementations, liquids evaporating at the opening 108 may leave residual deposits leading to port clogging over time. Through systematic port clearing, embodiments of the subject technology may enhance system reliability when exposed to chemical aggressors.

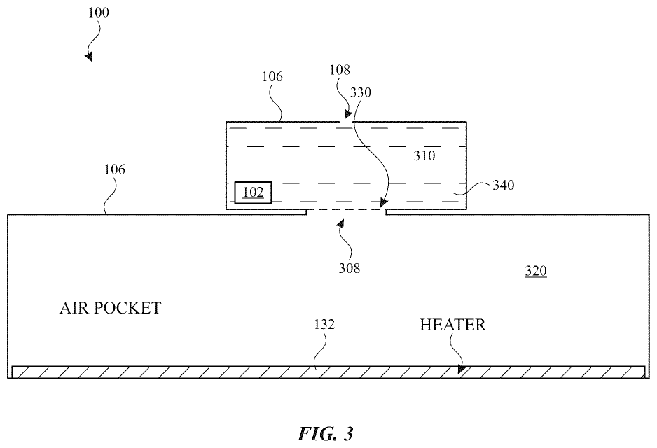

FIG. 3 illustrates a cross-sectional side view of a liquid occluded pressure sensor port in a housing of an electronic device in accordance with various aspects of the subject technology. Specifically, FIG. 3 shows a cross-sectional side view of a portion of device 100 at the location of opening 108. As shown in FIG. 3, pressure sensor 102 is disposed within housing 106 adjacent the opening 108 in housing 106 such that pressure sensor 102 receives airflow through opening 108. A pressure sensor port for pressure sensor 102 is formed by opening 108 and a cavity 310, within housing 106 and adjacent the opening 108, within which pressure sensor 102 is disposed. In one or more implementations, at least one opening (e.g., opening 308) is formed between the cavity 310 and a cavity 320 adjacent to the cavity 310.

In the example of FIG. 3, pressure sensor 102 may be provided with access to the airflow from the external environment through opening 108. However, liquid aggressors (e.g., water, oil, soap, etc.) and/or other environmental aggressors such as dust or dirt may enter through the opening 108 and occlude the pressure sensor 102 and/or the port formed by opening 108 and cavity 310 from receiving unobstructed airflow for environmental pressure sensing. In this regard, FIG. 3 illustrates a scenario in which a liquid 340 (e.g., water) has entered and at least partially filled cavity 310.

The occluding liquid can cause pressure changes or variations at the pressure sensor 102. For example, liquid getting trapped in cavity 310 due to film forming within the opening 108 can cause liquid 340 to accumulate in cavity 310, thereby generating an increase in pressure in cavity 310. This increase in pressure can, if the occlusion by the liquid is not detected, be falsely identified as a change in elevation of device 100.

As illustrated in FIG. 3, the pressure sensor port comprised of the opening 108 and the cavity 310 are adjacent to a gas pocket that is formed by the opening 308 and the cavity 320. Enclosed within this gas pocket, the air is subjected to the ideal gas law, experiencing an initial pressure of approximately 100 kPa and a temperature of around 290 K under ambient conditions. The subject technology involves the implementation of a gas volume, segregated from the pressure sensor 102 and port volume (e.g., volume inside cavity 310), which is filled with water and separated by a membrane with high water entry pressure but allowing air passage. In one or more implementations, the opening 308 has a capillary force that prevents at least a portion of the liquid 340 present in the cavity 310 from entering the cavity 320. As also shown in FIG. 3, the device 100 includes a particulate protection element 330 disposed within the opening 308. In one or more implementations, the particulate protection element 330 may be a mesh or a membrane serving as a water barrier. In one or more other implementations, the particulate protection element 330 includes gas permeable waterproof membranes, such as barometric vents.

As illustrated in FIG. 3, the heater 132 is positioned inside the cavity 320. The subject technology involves pressurizing the air within the gas pocket (e.g., cavity 320) via a temperature increase induced by the heater. By utilizing the heater 132 within the gas pocket, the air temperature can be increased. This elevated pressure is utilized to expel water from both the pressure sensor and pressure sensor port (e.g., cavity 310). In one or more implementations, the primary opposing force to be overcome is the capillary action of water, which determines the water entry pressure, reliant on the port geometry and/or sensor geometry. Capillary action can occur when a liquid (e.g., water) rises or falls in a narrow tube or porous material due to surface tension and adhesive forces. The pressure required for water to enter a capillary may depend on the diameter of the opening 108 and the angle at which the water enters. In this regard, as the diameter of the entry port decreases, the water entry pressure required increases due to increased surface tension and adhesive forces. For example, smaller entry ports (narrower tubes) may require higher pressures for water to enter. Additionally, different contact angles affect the capillary action, with steeper angles requiring more pressure. In one or more other implementations, as the entry port diameter decreases, the water rise height increases due to increased surface tension and adhesive forces. In one or more implementations, steeper angles of entry may require higher pressures for water to rise. This entry pressure can be computed using the Young-Laplace equation, contingent upon factors such as the water-surface contact angle, water surface tension, and port geometry. In one or more implementations, this contact angle can be material and surface dependent. For metals, the contact angle can be in a range of 65° to 90°. For a contact angle of about 67° and a tube diameter of about 0.5 mm, the water entry pressure due to the capillary force can be above a certain pressure value (e.g., 225 Pa). Comparatively, the gravitational force exerted by water is orders of magnitude weaker than the force of 5 kPa acting on typical port cross-sections. In one or more implementations, the heated air functions akin to a thermally loaded spring, facilitated by the heater 132 to expel the liquid occlusion. For example, a mere 15 K rise in air temperature can lead to a pressure elevation of about 5 kPa within the gas pocket. Consequently, given the ambient pressure of 100 kPa, the gas applies force against the water, expelling it through the opening 108. Additionally, embodiments of the subject technology can facilitate maintaining the water-filled space volume (e.g., cavity 310) significantly smaller than that of the gas pocket (e.g., cavity 320) to prevent the gas expansion from reducing the pressure below ambient plus the water entry pressure.

In one or more implementations, an occlusion may be detected by processing circuitry such as processing circuitry 128 of FIG. 1. Upon determination that the pressure sensor 102 and/or the port formed by opening 108 and cavity 310 are occluded, the processing circuitry 128 takes corrective action. The corrective action may include operating an additional component within the housing 106 (e.g., the heater 132) to clear the occlusion. In one or more other implementations, the processing circuitry 128 may take other corrective action, such as providing a notification to a user of device 100 that the pressure sensor 102 is occluded, providing instructions to the user to clear the occlusion (e.g., by shaking the device or using a drying instrument in the port), preventing pressure sensor data obtained while the sensor was occluded from being used in other applications (e.g., to identify elevation changes and/or resulting exercise minutes), or providing an occlusion notice to other components and/or applications of the device 100 (e.g., to a speaker component to indicate the need to increase speaker volume).

For the pressure sensor 102, the heater 132 can be mechanically coupled to an inner wall of the cavity 320, enabling it to apply heat to the area within the cavity 320. In one or more implementations, the heater 132 may include a lining that wraps the inner walls of the cavity 320. The heater 132 may be implemented with thermal isolation, likened to a light bulb filament, to pursue optimal performance of the heater 132. In one or more other implementations, the heater 132 includes a coil and an insulation layer that surrounds the coil to facilitate the desired thermal isolation from the cavity 320 surroundings and/or housing 106. In one or more implementations, there may be intermediary components situated between the housing 106 and the heater 132. For example, a switching transistor or the conceptualization of a switch for activation may be included as an intermediate component.

In relation to the heater 132, pertinent characteristics warrant consideration to optimize its efficacy in facilitating efficient heating. This encompasses factors such as wire gauge, wire length, coil count, and the heat-conduction capacity necessary to achieve the desired heating rate for generating the intended gas pressure within the gas pocket. Furthermore, prioritizing slender wire dimensions is recommended to augment thermal conductivity. In a theoretical scenario, infinitesimally thin wire constitutes the ultimate ideal, where both wire length and voltage tend towards infinity, thereby optimizing thermal conductivity to realize the targeted heating objectives. Such a wire may be insulated to prevent corrosion, although a thicker coating may necessitate additional power consumption because of its own heat capacity and a reduction of the heat transferred to the gas pocket.

In the example of FIG. 3, the pressure sensor 102 is a water-resistant pressure sensor. However, liquid that enters cavity 310 can negatively affect the pressure measurements made using the pressure sensor 102. As illustrated in FIG. 3, the pressure sensor 102 is disposed within the cavity 310 of the device 100, along with the heater 132 disposed within the cavity 310 serving as the gas pocket. The air inside the gas pocket (e.g., the cavity 320) is pressurized by a temperature increase through the heater 132. This pressure is used to eject water out of the pressure sensor 102 and pressure sensor port formed by the opening 108 and the cavity 310.

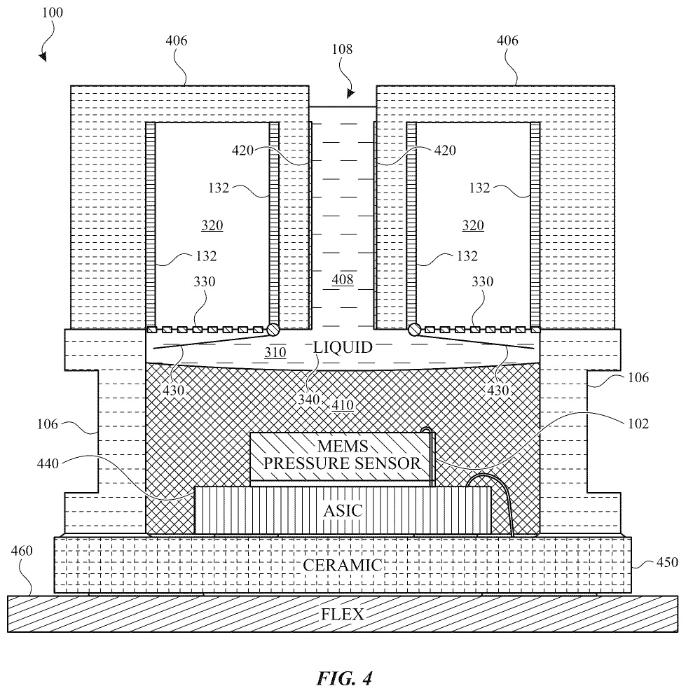

FIG. 4 illustrates a cross-sectional side view of a pressure sensor disposed in a pressure sensor port in a housing of an electronic device in accordance with various aspects of the subject technology. Specifically, FIG. 4 shows a cross-sectional side view of a portion of device 100 at the location of opening 108. As shown in FIG. 4, pressure sensor 102 is disposed within housing 106 adjacent the opening 108 in housing 106 such that pressure sensor 102 receives airflow through opening 108. A pressure sensor port for pressure sensor 102 is formed by the opening 108 and the cavity 310, within housing 106 and adjacent the opening 108, within which pressure sensor 102 is disposed. In one or more implementations, the device 100 includes an ASIC device 440 to translate the pressure signal to digital form. The pressure sensor 102 can be disposed on the ASIC device 440. In one or more implementations, the device 100 includes a substrate 450, such as ceramic. The ASIC device 440 may be disposed on the substrate 450. In one or more implementations, the device 100 includes an interconnector layer 460, such as flex. The substrate 450 may be disposed on and electrically connected to the interconnector layer 460.

In the example of FIG. 4, pressure sensor 102 is a water-resistant pressure sensor having a waterproofing encapsulation 410 such as a waterproofing gel layer disposed over the pressure sensor 102 to prevent liquid 340 from contacting the pressure sensor 102 electronics. However, liquid 340 that enters cavity 310 can impact waterproofing encapsulation 410 and can negatively affect the pressure measurements made using pressure sensor 102. As illustrated in FIG. 4, the pressure sensor 102 is disposed within the opening 108 of the device 100 and embedded within the waterproofing encapsulation 410 depicted as a gel layer.

As illustrated in FIG. 4, the gas pocket (formed by the cavity 320) and the heater 132 are implemented into the pressure sensor port. In one or more implementations, FIG. 4 shows a cross-sectional view of a cylindrical structure 406, indicating the presence of one gas pocket that wraps around a passageway 408 of the pressure sensor port. Conceptually, it can resemble a tube situated within the cylindrical structure 406. For example, the cylindrical structure 406 includes a shape that wraps around the passageway 408 adjacent the opening 108. In one or more implementations, the cavity 320 is arranged within the shape of the cylindrical structure 406 with access to the cavity 310. The port geometry of the opening 108 can vary considerably from the illustration in FIG. 4.

In one or more implementations, the heater 132 may consist of either a wire (e.g., copper coil) or a conductive foil lining (e.g., copper foil). In one or more other implementations, the heater 132 is formed by wrapping a wire-resistant coil around an inner part of the cylindrical structure 406. In one or more other implementations, for the heater 132, a copper foil is considered for external placement on the cylindrical structure 406. This copper foil can accommodate a resistor feeder attached to a copper coil. When current is applied through a resistor, heat is generated. Copper, as a thermal conductor, distributes the heat throughout the cavity 320 within the cylindrical structure 406. In one or more other implementations, the heater 132 can be composed of a thin film of a suitable metal (e.g., copper).

In one or more implementations, the particulate protection element 330 (e.g., a membrane or mesh) is present at the bottom of the cavity 320 along with a valve mechanism (e.g., valve 430) that can be moved to open or close the cavity 320. In one or more implementations, the primary objective is to facilitate the protection of the cavity 320 to prevent any unwanted ingress of the liquid 340 into the cavity 320. This can be achieved using different methods, depending on factors such as the expected water pressure. For instance, in an electronic device designed for diving where water pressure can be significant, additional measures may be necessary to safeguard the cavity 320. In one or more implementations, when water pressure increases, the valve 430 is pushed against the particulate protection element 330 and/or the cavity 320, sealing off the cavity 320. For example, the valve 430 may couple to a sealing surface of the cavity 320. Upon a user of the device 100 exiting the water, the pressure inside the cavity 320 may need to exceed the water entry pressure, which can be calculated using the Young-Laplace equation. This equation accounts for factors such as the port geometry and surface tension. In one or more other implementations, activity signals, such as when the user emerges from a diving event, are monitored on the electronic device 100 to determine one or more expected pressure states. As the user exits the water and the pressure inside the cavity 320 decreases, sufficient pressure may need to be maintained to both seal off the cavity 320 and eject any water present in the cavity 310. This mechanism can facilitate that the cavity 320 is protected not only by the particulate protection element 330 but also by the valve 430, such as a hinged valve cover. In cases where large water pressure is not expected, such as for devices not intended for submersion, the particulate protection element 330 alone may suffice for protection. However, employing additional measures, such as the valve 430, provides another layer of protection.

In relation to the volume of the gas pocket (formed by at least the cavity 320) in comparison to the cavity 310 and the port (formed by at least the passageway 408 adjacent the opening 108), there may be a specific ratio between the gas pocket and the cavity 310. As the air from the gas pocket expands into the rest of the pressure sensor port, including the water-filled port and pressure sensor (not shown), there is an increase in air volume, which alone would reduce pressure, even if the air remained at the same temperature. This pressure drop may not be sufficient to overcome the water entry pressure of the small orifice (e.g., the opening 108). The volume ratio may be determined by this factor. Therefore, a significant ratio of gas pockets to the overall cavity volume of the device 100 can be targeted to allow water flow, although this ratio is not fixed, as the temperature change of the gas pocket may be another variable. There can be a trade-off between expanding air pressure in the gas pocket and minimizing heating energy costs. Although a protected gas pocket (e.g., cavity 320) may have a specific volume ratio relative to the water pocket (e.g., liquid 340 in the cavity 310 and passageway 408 to the opening 108), the shape of the gas pocket and whether it needs to be singular or connected to the water volume may not be predetermined.

As for the triggering mechanism, activation could, for example, occur upon water detection, which encompasses various detection techniques and considerations. The system may automatically detect moisture, or the occluded liquid ejection mechanism can be manually activated by a user. Simultaneously, pressure measurement confirms its effectiveness. If no pressure change accompanies the release of air, indicating no occlusion, the system ceases operation. Heating is initiated once confirmation is obtained that water ejection from the housing 106 is warranted. In one or more implementations, the device 100 includes capacitor electrodes 420 to sense the liquid in the pressure sensor port, particularly within the opening 108 and in the passageway 408, and trigger the ejection procedure with the heater 132. In one or more implementations, the powering of the heater 132 is achieved through certain control signaling designed to activate the heating. In one or more other implementations, capacitor electrodes 420 can be utilized to enable the measurement of capacitance between two plates. The capacitance value is significantly influenced by the presence or absence of a liquid between the plates, given the difference in dielectric constants between the liquid 340 (e.g., water) and air.

In one or more other implementations, the utilization of MEMS detection by way of the pressure sensor 102 serves as an alternative or supplementary method to the detection facilitated by the capacitor electrodes 420. Regarding water detection, this arrangement exemplifies a scenario where the passageway 408 from the opening 108 into the cavity 310 may be obstructed. Upon activating the heater 132, no increase in pressure may be observed if the passageway 408 remains clear. However, if water is present in the passageway 408, the air pressure would rise, allowing measurement via the pressure sensor 102. In one or more implementations, if air escapes and fills the cavity 310 upon heating initiation, this change in pressure could be detected using the pressure sensor 102. Hence, multiple options exist for monitoring and facilitating water ejection.

The operation of the heater 132 in the implementation as depicted in FIG. 4 is similar to the operation discussed in FIG. 3, where the objective is to alter the gas temperature by generating heat within the cavity 320 with the heater 132, inducing pressure changes within the gas pocket by increasing the air pressure within the cavity 320 to expel the occluding liquid from the cavity 310 through the opening 108 with outward pressures formed by the expending gas pocket. According to the ideal gas law, increasing the temperature leads to higher pressure. The gas within the gas pocket expands, exerting force on any water present. This force effectively ejects the water out of the cavity 310.

In one or more other implementations, the device 100 includes multiple gas pockets situated in the pressure sensor port. In the case of two or more gas pockets, the gas pockets may have similar dimensions, although they can vary depending on implementation. For example, the dimensions between the two gas pockets can differ significantly, likely with less height above the center and spread out in the x-y direction. In one or more implementations, the device 100 having more than one gas pocket for thermally controlled pressure modulation has advantages over legacy devices with protected cavities. For example, multiple smaller volume gas pockets can be heated more quickly due to their reduced size, even though heating of additional areas may be facilitated. Maximizing the surface area can enhance the heating efficiency by providing more heating surfaces for adjusting the temperature of a gas-filled cavity. In one or more implementations, certain materials may be used for surrounding components to prevent unnecessary heat transfer. In this regard, the objective is to confine the heat as efficiently as possible within the gas pocket to conserve energy. In one or more other implementations, the device 100 can incorporate multiple chimneys instead of a single chimney to form different gas pockets, ensuring that occlusion of one chimney does not compromise the pressure signal. In this regard, additional paths may be formed for a pressure sensor (e.g., the pressure sensor 102) to ensure reliable operation. In one or more implementations, introducing multiple chimneys may cause a potential loss of pressure if one chimney becomes unplugged, thereby reducing the buildup of pressure needed for proper functioning of the occluded liquid ejection. In one or more other implementations, the device 100 may include separate ports providing additional paths with respective gas pockets can facilitate the simultaneous clearance of multiple paths for enhancing the overall functionality and efficiency of the occluded liquid ejection mechanism.

In one or more other implementations, the ratio of air volume to the casing, particularly for each pair of gas pockets in relation to the intended water volume clearance, can be determined. This ratio can be calculated based on the energy required for efficient expansion. The utilization of multiple gas pockets as backups for occluded liquid ejections can be beneficial. For example, if a gas pocket is situated deep within a water-filled area, activating the heater 132 may result in heat loss and air displacement, leading to a reduction in pressure. Consequently, the gas pocket can become ineffective for further liquid ejection. The inclusion of multiple gas pockets can enable consecutive ejection cycles, ensuring that the liquid 340 can be ejected as required without relying solely on a single gas pocket. This flexibility can allow for precise control over the ejected water volume, optimizing the functionality of the occluded liquid ejection mechanism.

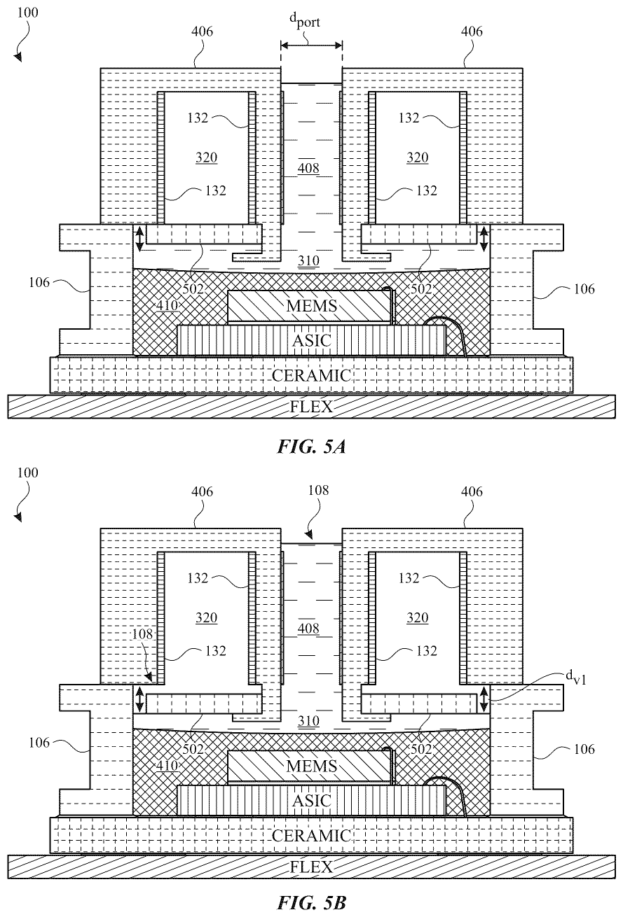

FIG. 5A illustrates a cross-sectional side view of the pressure sensor 102 disposed in a pressure sensor port in the housing 106 of the electronic device 100 with a one-way valve in a closed position in accordance with various aspects of the subject technology. FIG. 5B illustrates a cross-sectional side view of the pressure sensor 102 disposed in the pressure sensor port in the housing 106 of the electronic device 100 with the one-way valve in a closed position in accordance with various aspects of the subject technology. In one or more implementations, the heater 132 is formed on one or more cavity walls of the cavity 320. In one or more implementations, the device 100 includes the waterproofing encapsulation 410 such as a waterproofing gel layer disposed over the electronics disposed in the cavity 310. The operation of the heater 132 in the implementation as depicted in FIGS. 5A and 5B is similar to the operation discussed in FIGS. 3 and 4, where the objective is to alter the gas temperature by generating heat within the cavity 320 with the heater 132, inducing pressure changes within the gas pocket by increasing the air pressure within the cavity 320 to expel the occluding liquid from the cavity 310 through the opening 108 with outward pressures formed by the expending gas pocket. For purposes of brevity of explanation, only the differences in the structure and operation of the occluded liquid ejection mechanism will be discussed with reference to FIGS. 5A and 5B.

In one or more implementations, FIGS. 5A and 5B show a cross-sectional view of the cylindrical structure 406 as described with reference to FIG. 4, indicating the presence of one gas pocket (e.g., cavity 320) that wraps around the passageway 408 of the pressure sensor port. In one or more implementations, the gas pocket (formed by at least the cavity 320) may be protected from water ingress using a one-way valve (e.g., valve 502) that is closed automatically by the water entering the pressure sensor port as illustrated in FIG. 5A and opened in response to an increase in air pressure in the gas pocket by heating the cavity 320 with the heater 132 as illustrated in FIG. 5B. In one or more implementations, FIG. 5 shows a cross-sectional view of a valve 502. In one or more implementations, the valve 502 is implemented as a movable washer mechanism. For example, the valve 502 may move vertically up and down (or in a direction along a longitudinal axis of the passageway 408 of the opening 108). In one or more implementations, the cross-sectional view of the valve 502 indicates the presence of one movable washer mechanism that wraps around the passageway 408 of the pressure sensor port. As illustrated in FIG. 5A, the passageway 408 has a dimension defined as dₚₒᵣₜ. As illustrated in FIG. 5B, when the valve 502 is in the open position, the gap formed between the bottom of the cylindrical structure 406 and the plane of the water surface has a dimension defined as dᵥ₁. In one or more implementations, dₚₒᵣₜ is significantly larger than dᵥ₁, causing the water entry pressure into the gas pocket (e.g., into the cavity 320) to be significantly larger than the water entry pressure of the pressure sensor port at the opening 108. Thus, the valve 502 can protect the gas pocket from water entry even for scenarios when the pressure sensor 102 supports certain user activities (e.g., diving).

In one or more implementations, the influence of water pressure in the pressure sensor port may be determined by the geometry of the pressure sensor port (including the opening 108, the passageway 408 to/from the opening 108, the cavity 310). In one or more implementations, the shape of the passageway 408 to/from the opening 108 may be represented similarly to a straw. Analogous to a capillary, where the width of the straw affects the occluding liquid's height (or water surface level), the wider the port, the lower the pressure. Conversely, narrower ports result in higher water entry pressure. Therefore, while some water can ingress to the gap formed after the valve 502 is in the open position, the smaller size of this gap defined by dᵥ₁ compared to the port formed by the opening 108 (and/or the passageway 408) means the water entry pressure at the dᵥ₁ gap is significantly higher. In this regard, water can be prevented from entering the gas pocket (e.g., cavity 320) via the open gap formed after the valve 502 is open and instead air pressure can be exerted onto valve 502 (and into the gap).

In one or more other implementations, a mesh may also be included to further enhance protection against water ingress while maintaining functionality. In this regard, this configuration can incorporate a one-way valve mechanism (e.g., the valve 502) alongside the mesh for added protection. When water pressure increases, the valve 502 is pushed against the gas pocket, effectively sealing it. For example, the valve 430 may couple to a sealing surface of the cavity 320 and/or a sealing surface of the cylindrical structure 406. As a user emerges from water, the pressure drops to the water entry level. By maintaining pressure in the gas pocket, even greater than the water entry pressure, the system can eject the water.

In one or more implementations, a pressure sensor (e.g., pressure sensor 102 of FIG. 1) can be utilized to detect a temporary increase in pressure when the valve 502 opens and the water is ejected. Once the ejection event is complete, the pressure measured by the pressure sensor 102 returns to ambient levels, providing feedback on the completion of the occluded liquid ejection process. In one or more other implementations, the pressure may be measured continuously or at a programmable iteration.

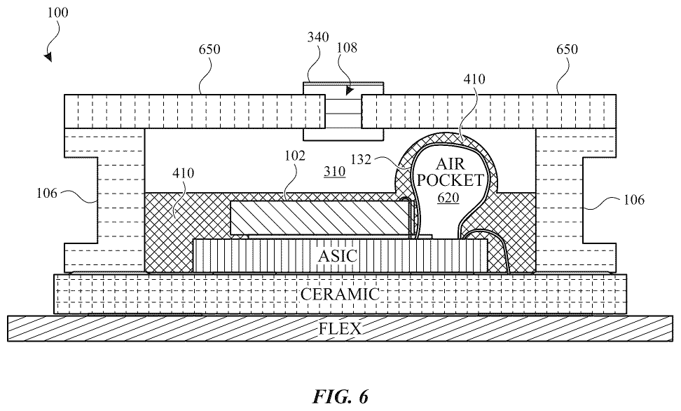

FIG. 6 illustrates a cross-sectional side view of the pressure sensor 102 disposed in a pressure sensor port in the housing 106 of the electronic device 100 in accordance with various aspects of the subject technology. In one or more implementations, the electronic device 100 includes a protective cap 650 that couples to a sealing surface of the housing 106 such that the cavity 310 is formed therein. The protective cap 650 includes the opening 108 that provides electronics disposed within the cavity 310 with access to an external environment. In one or more implementations, the electronic device 100 includes the heater 132 disposed in the cavity 310. In one or more implementations, the device 100 includes the waterproofing encapsulation 410 such as a waterproofing gel layer disposed over the electronics disposed in the cavity 310. The operation of the heater 132 in the implementation as depicted in FIG. 6 is similar to the operation discussed in FIGS. 3, 4, 5A and 5B, where the objective is to alter the gas temperature by generating heat within a gas pocket 620 with the heater 132, inducing pressure changes within the cavity 310 by increasing the gas pressure within the gas pocket 620 to expel the occluding liquid from the cavity 310 through the opening 108 with outward pressures formed by the expending gas pocket 620. For purposes of brevity of explanation, only the differences in the structure and operation of the occluded liquid ejection mechanism will be discussed with reference to FIG. 6.

The gas pocket 620 can be formed by making a shape of the heater 132 with one or more wire bonds that may not be fully penetrated by an uncured gel. For example, the gas pocket 620 formed within the shape of the heater 132 is separated from water ingress by a thin low modulus film, such as a gel film layer (e.g., the waterproofing encapsulation 410). The heater 132 can be used to expand the gel film layer to increase the air pressure in the cavity 310 by causing a change in temperature of the gas volume in the cavity 310. Increased pressure in the cavity 310 can break the water film formed at the opening 108, allowing the air pressure to equalize to the external environment.

In one or more implementations, the heater 132 can take various forms, not limited to just a wire bond. In one or more other implementations, the heater 132 may be implemented as a coil or another type of wire, possibly made of a material with higher resistance compared to a wire bond. The configuration of the heater 132 can remain relatively unchanged during expansion; instead, it is the gel film layer surrounding the heater 132 that can undergo significant movement. For example, the gel film layer may expand much like a balloon when heated. This expansion of the gel film layer can exert pressure, causing the gas pocket 620 to enlarge and displace the liquid 340 occluding the opening 108. In one or more implementations, there can be a transfer of heat from the gel film layer to the air or gas within the cavity 310. As the gel film layer expands due to heating, it heats up the surrounding air or gas, thereby increasing its temperature and pressure. This increase in pressure facilitates the ejection of the liquid 340 from the cavity 310. In one or more other implementations, the gel film layer (e.g., the waterproofing encapsulation 410) may not be present, with a shaped heating element (e.g., the heater 132) employed to achieve comparable results.

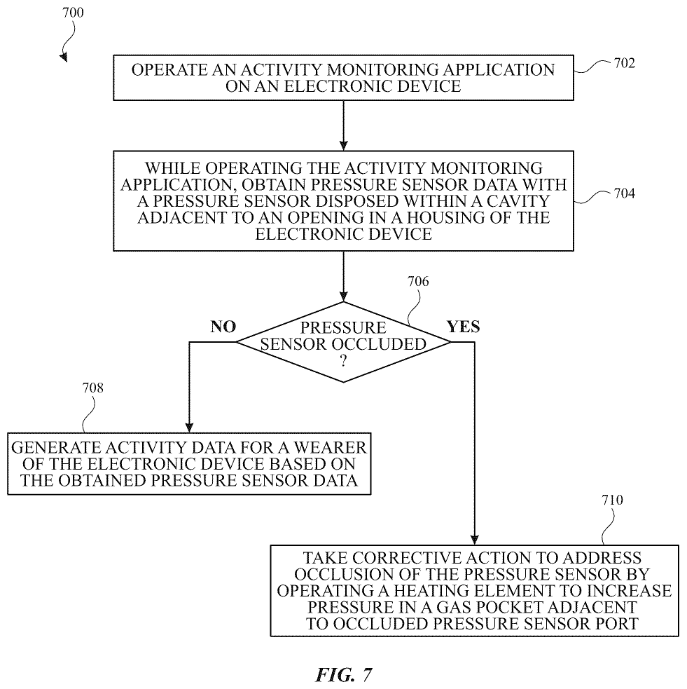

FIG. 7 depicts a flow diagram of an example process for operation of device 100, in accordance with various aspects of the subject technology. For explanatory purposes, the example process of FIG. 7 is described herein with reference to the components of FIGS. 3, 4, 5A-5B and 6. Further for explanatory purposes, some blocks of the example process of FIG. 7 are described herein as occurring in series, or linearly. However, multiple blocks of the example process of FIG. 7 may occur in parallel. In addition, the blocks of the example process of FIG. 7 need not be performed in the order shown and/or one or more of the blocks of the example process of FIG. 7 need not be performed. Additionally, the blocks of the example process of FIG. 7 are described herein for illustration purposes and performance of these blocks may vary depending on implementation without departing from the scope of the present disclosure.

In the depicted example flow diagram, at step 702, an activity monitoring application of a wearable electronic device 100 such as smart watch of FIG. 2 may be operated. Operating the activity monitoring application may include monitoring an activity of a wearer of a smart watch with the activity monitoring application of the smart watch (e.g., by monitoring the position, motion, elevation, acceleration, and/or position of device 100 using various sensors within the device 100).

At step 704, while operating the activity monitoring application, pressure data may be obtained with a pressure sensor (e.g., pressure sensor 102) disposed adjacent an open port (e.g., opening 108) in a housing (e.g., housing 106) of the wearable electronic device.

At step 706, processing circuitry such as processing circuitry 128 determines whether the pressure sensor and/or the open port are occluded. For example, occlusion may be detected when a change in pressure within a specific window of time is detected. In another example, occlusion may be detected based on a change in capacitance between two plates (arranged across the pressure sensor port).

At step 708, if no occlusion is detected, activity data such as exercise statistics may be generated for a wearer of the wearable electronic device (e.g., using the pressure data by converting a barometric pressure measured by the pressure sensor into a device elevation). For example, one or more flights of stairs may be awarded to the wearer using a change in elevation determined using the determined measured pressure.

At step 710, if occlusion is detected, processing circuitry such as processing circuitry 128 may proceed to take corrective action to address occlusion of the pressure sensor or the open port. Correction action can include, as one example, rejecting the pressure sensor data from inclusion in determining exercise statistics for the wearer of device 100. For example, a heater of the device such as heater 132 may be operated to mitigate the occlusion. In one or more implementations, heater 132 may be a heating element disposed in cavity 320. Heater 132 may be operated to generate heat to facilitate ejection of a liquid occlusion by causing a change in temperature in the cavity 320 thus causing an increase in pressure in the cavity 320 that is used to expel the liquid from the occluded cavity 310 adjacent to the cavity 320, as described with reference to FIGS. 3, 4, 5A-5B and 6. In one or more other implementations, an additional water sensing step may be performed before activation of the heater 132. For example, following a swimming workout, a delay may be applied until the absence of water detection on the display 110 of the electronic device 100 is confirmed before activating the heater 132. This precautionary measure can prevent the inadvertent activation of the heater 132 while a user is still immersed in a swimming pool, thereby mitigating the risk of attempting to dry the pressure sensor 102 under such conditions.

Although the example of FIG. 7 describes the use of pressure sensor data (and associated occlusion detection operations) in the context of determining exercise statistics by an activity monitoring application of a wearable electronic device, it will be appreciated that the occlusion detection operations described herein can be applied to a microphone disposed in a cavity, a speaker disposed in a cavity, or pressure sensors disposed in other devices and used for other applications, some examples of which have been described herein.

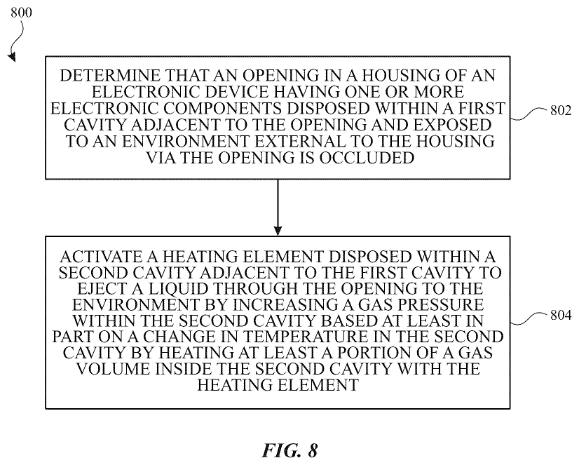

FIG. 8 depicts a flow diagram of an example process for determining whether the pressure sensor and/or the open port are occluded, in accordance with various aspects of the subject technology. For explanatory purposes, the example process of FIG. 8 is described herein with reference to the components of FIGS. 3, 4, 5A-5B and 6. Further for explanatory purposes, some blocks of the example process of FIG. 8 are described herein as occurring in series, or linearly. However, multiple blocks of the example process of FIG. 8 may occur in parallel. In addition, the blocks of the example process of FIG. 8 need not be performed in the order shown and/or one or more of the blocks of the example process of FIG. 8 need not be performed.

At step 802, processing circuitry such as processing circuitry 128 determines that an open port (e.g., opening 108) in a housing (e.g., housing 106) of a wearable electronic device (e.g., device 100) having one or more electronic components (e.g., pressure sensor 102, input/output components 126 such as a microphone or a speaker) disposed within a first cavity (e.g., cavity 310) adjacent to the opening 108 and exposed to an environment external to the housing 106 via the opening 108 is occluded. In one or more implementations, the opening 108 is occluded by a liquid 340 (e.g., water).

At step 804, processing circuitry 128 activates a heating element (e.g., the heater 132) disposed within a second cavity (e.g., the cavity 320) adjacent to the cavity 310 to eject the liquid through the opening 108 to the environment by increasing a gas pressure within the cavity 320 based at least in part on a change in temperature in the cavity 320 by heating at least a portion of a gas volume inside the cavity 320 with the heater 132.

In accordance with various aspects of the subject disclosure, an electronic device is provided that includes a housing having an opening. The electronic device also includes one or more electronic components disposed within a first cavity adjacent to the opening and exposed to an environment external to the housing via the opening. The electronic device also includes a heating element disposed within a second cavity adjacent to the first cavity. The electronic device also includes processing circuitry configured to determine that the opening is occluded by a liquid; and activate the heating element to eject the liquid through the opening to the environment by increasing a gas pressure within the second cavity based at least in part on a change in temperature in the second cavity by heating at least a portion of a gas volume inside the second cavity with the heating element.

In accordance with other aspects of the subject disclosure, a smart watch is provided that includes a housing having an opening. The smart watch also includes one or more electronic components disposed within a first cavity adjacent to the opening and exposed to an environment external to the housing via the opening. The smart watch also includes a heating element disposed within a second cavity adjacent to the first cavity and configured to heat at least a portion of a gas volume inside the second cavity to cause an increase in a gas pressure within the second cavity based at least in part on a change in temperature in the second cavity. In some aspects, the opening is occluded by a liquid, and the liquid is displaced by the increase in the gas pressure from the second cavity to the first cavity.

In accordance with other aspects of the subject disclosure, an electronic device is provided that includes a housing and a particulate protection element having an opening and arranged on at least a portion of the housing. The electronic device also includes one or more electronic components disposed within a cavity adjacent to the opening and exposed to an environment external to the housing via the opening. The electronic device also includes a heating element disposed within the cavity and configured to heat at least a portion of a gas pocket formed inside a shape of the heating element to cause an increase in a pressure within the gas pocket based at least in part on a change in temperature in the gas pocket. The electronic device also includes a gel layer positioned inside the cavity and disposed on at least a portion of the one or more electronic components and the heating element. In some aspects, at least a portion of the gel layer expands in response to the change in temperature in the gas pocket to cause an increase in pressure in the cavity to cause displacement of an occluding liquid at the opening.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device as described herein for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An electronic device, comprising:
a housing having an opening;
one or more electronic components disposed within a first cavity adjacent to the opening and exposed to an environment external to the housing via the opening;
a heating element disposed within a second cavity adjacent to the first cavity; and
processing circuitry configured to:
determine that the opening is occluded; and
activate the heating element to eject a liquid through the opening to the environment by increasing a gas pressure within the second cavity based at least in part on a change in temperature in the second cavity by heating at least a portion of a gas volume inside the second cavity with the heating element.

2. The electronic device of claim 1, further comprising a particulate protection element disposed between the second cavity and the first cavity.

3. The electronic device of claim 1, further comprising a valve disposed adjacent to the second cavity and configured to transition between a closed position and an open position to control transfer of the gas pressure from the second cavity to the first cavity.

4. The electronic device of claim 3, wherein the valve is configured to couple to a sealing surface of the second cavity.

5. The electronic device of claim 3, wherein the transition between the closed position and the open position of the valve comprises a lateral movement along a longitudinal axis of an entry passageway adjacent the opening or along a longitudinal axis of the second cavity.

6. The electronic device of claim 3, wherein the open position of the valve forms a gap adjacent the second cavity that has a first dimension smaller than a second dimension defining a geometry of the opening, wherein a pressure of the liquid present adjacent to the gap is greater than the pressure of the liquid at the opening.

7. The electronic device of claim 1, further comprising a gel layer positioned inside the first cavity and disposed on at least a portion of the one or more electronic components.

8. The electronic device of claim 1, wherein the heating element comprises one or more layers of a conductive foil disposed on one or more walls of the second cavity.

9. The electronic device of claim 1, wherein the heating element comprises one or more wire bonds.

10. The electronic device of claim 1, further comprising a cylindrical structure arranged adjacent to at least a portion of the housing, wherein the cylindrical structure includes a shape that wraps around an entry passageway adjacent the opening, wherein the second cavity is arranged within the shape of the cylindrical structure with access to the first cavity.

11. The electronic device of claim 10, further comprising one or more capacitor electrodes arranged on one or more walls of the cylindrical structure along the entry passageway and configured to detect presence of the liquid in at least the entry passageway.

12. The electronic device of claim 1, wherein at least one opening is formed between the second cavity and the first cavity, wherein the at least one opening between the second cavity and the first cavity has a capillary force that prevents at least a portion of the liquid present in the first cavity from entering the second cavity.

13. A smart watch, comprising:
a housing having an opening;
one or more electronic components disposed within a first cavity adjacent to the opening and exposed to an environment external to the housing via the opening;
a heating element disposed within a second cavity adjacent to the first cavity and configured to heat at least a portion of a gas volume inside the second cavity to cause an increase in a gas pressure within the second cavity based at least in part on a change in temperature in the second cavity,
wherein the opening is occluded by a liquid, and wherein the liquid is displaced by the increase in the gas pressure from the second cavity to the first cavity.

14. The smart watch of claim 13, further comprising a valve disposed adjacent to the second cavity and configured to transition between a closed position and an open position to control transfer of the gas pressure from the second cavity to the first cavity, wherein the valve is configured to couple to a sealing surface of the second cavity, wherein the transition between the closed position and the open position of the valve comprises a lateral movement along a longitudinal axis of an entry passageway adjacent the opening or along a longitudinal axis of the second cavity, and wherein the open position of the valve forms a gap adjacent the second cavity that has a first dimension smaller than a second dimension defining a geometry of the opening, wherein a pressure of the liquid present adjacent to the gap is greater than the pressure of the liquid at the opening.

15. The smart watch of claim 13, further comprising a gel layer positioned inside the first cavity and disposed on at least a portion of the one or more electronic components.

16. The smart watch of claim 13, wherein the heating element comprises one or more layers of a conductive foil disposed on one or more walls of the second cavity.

17. The smart watch of claim 13, wherein the heating element comprises one or more wire bonds.

18. The smart watch of claim 13, further comprising a cylindrical structure arranged adjacent to at least a portion of the housing, wherein the cylindrical structure includes a shape that wraps around an entry passageway adjacent the opening, wherein the second cavity is arranged within the shape of the cylindrical structure with access to the first cavity.

19. The smart watch of claim 18, further comprising one or more capacitor electrodes arranged on one or more walls of the cylindrical structure along the entry passageway and configured to detect presence of the liquid in at least the entry passageway.

20. An electronic device, comprising:
a housing;
a particulate protection element having an opening and arranged on at least a portion of the housing;
one or more electronic components disposed within a cavity adjacent to the opening and exposed to an environment external to the housing via the opening;
a heating element disposed within the cavity and configured to heat at least a portion of a gas pocket formed inside a shape of the heating element to cause an increase in a pressure within the gas pocket based at least in part on a change in temperature in the gas pocket; and
a gel layer positioned inside the cavity and disposed on at least a portion of the one or more electronic components and the heating element, wherein at least a portion of the gel layer expands in response to the change in temperature in the gas pocket to cause an increase in pressure in the cavity to cause displacement of an occluding liquid at the opening.
